(19) United States
(12) Patent Application Publication
(10) Pub. No.: US 2014/0005967 A1
(43) Pub. Date: Jan. 2, 2014

(54) METHODS AND SYSTEMS FOR CHARACTERIZING AND IDENTIFYING ELECTRONIC DEVICES

(71) Applicants: Kevin E. Fu, Hadley, MA (US); Daniel E. Holcomb, Berkely, CA (US); Wayne P. Burleson, Shutesbury, MA (US)

(72) Inventors: Kevin E. Fu, Hadley, MA (US); Daniel E. Holcomb, Berkely, CA (US); Wayne P. Burleson, Shutesbury, MA (US)

(21) Appl. No.: 13/930,855

(22) Filed: Jun. 28, 2013

Related U.S. Application Data
(60) Provisional application No. 61/666,082, filed on Jun. 29, 2012.

(51) Int. Cl. G06F 11/30

(52) U.S. Cl. CPC G06F 11/30
USPC 702/80

(57) ABSTRACT

The present disclosure provides a method and a system for characterizing and identifying an electronic device using a physical fingerprint. In one aspect, the characterizing method includes determining the physical fingerprint of a test device using selected memory cells of an SRAM array in the test device, and storing data associated with the physical fingerprint in a database. The physical fingerprint of the test device includes data retention voltages respectfully corresponding to the selected memory cells. In one aspect, the identifying method includes characterizing a test device using data retention voltages of selected memory cells in the test device as a physical fingerprint of the test device, and comparing the physical fingerprint of the test device with a predetermined fingerprint of a target device.

### RELATED APPLICATION

This application claims the benefit of priority to U.S. Provisional Application No. 61/666,082, filed on Jun. 29, 2012, the entire contents of which are incorporated herein by reference in its entirety and for all purposes.

### STATEMENT OF GOVERNMENT SPONSORED RESEARCH

This invention was made partially with U.S. Government support from the NSF grants CNS-0964641, CNS-0923313, CNS-0845874, and SRC task 1836.074.

### BACKGROUND

The present disclosure relates to a system and a method for identifying or authenticating circuits using static identifiers. More particularly, the present disclosure relates to a system and a method for identifying or authenticating circuits using physical fingerprints, such as the data retention voltage (DRV) of static random access memory (SRAM).

RFID circuits can be identified or authenticated using static identifiers stored in non-volatile memory or through the use of identifying physical characteristics. Physical characteristics have several security advantages over static identifiers, including immutability and resistance to cloning and tampering. The physical characteristics can be viewed as an identifying fingerprint of a given device. More formally, physical fingerprints may be a component of a particular type of physical unclonable function (PUF) that is originally described as a physically obfuscated key, and more recently as a weak PUF.

A wide variety of PUFs and fingerprints based on custom or pre-existing integrated circuit components have been developed. The identifying features used by custom designs include MOSFET drain-current, timing race conditions, and the digital state taken by cross-coupled logic after a reset.

IC identification based on pre-existing circuitry is demonstrated using SRAM power-up state, and physical variations of ash memory. A secret key unique to each IC may be derived using the statistical delay variations of wires and transistors across ICs. Circuit-level techniques have been explored for increasing the reliability of SRAM PUFs. An experimental evaluation of low-temperature data remanence on a variety of SRAMs has been provided, and SRAM remanence in RFID has been studied as a limitation to SRAM-based true random number generation.

Previous works have used error correction to construct secret keys from noisy PUF sources; however, this is expensive in terms of gates and other resources. To give an idea of the cost of error correction, BCH codes previously used with PUFs include one to correct 21 errors among 127 raw bits in creating a 64-bit key, and to correct 102 errors among 1023 raw bits in creating a 278-bit key. A derivative of power-up SRAM state has been used as a secret key; however, it requires an error correction code and imposes SRAM space overhead. An SRAM helper data algorithm has been introduced to mask unreliable bits using low-overhead post-processing algorithms. Recently, a method of error correction for PUFs using a new syndrome coding scheme has been proposed to minimize the information leaked by the error correction codes. This approach has been extended for SRAM PUFs. A new lightweight authentication scheme has been designed using PUFs that does not require the reader to store a large number of PUF challenge and response pairs.

If used for identification or constructing secret keys, fingerprint observations must be consistent over time. Sensing the microscopic variations that make each device unique while also minimizing the impact of noise is a fundamental concern in PUFs. Much effort is spent on error correction of somewhat-unreliable fingerprints or PUF outputs. Error correcting codes are expensive in terms of the number of raw bits required to create a reliable key, and more so if the number of correctable errors must be large.

There is a need for methods and systems for chip fingerprint that are more reliable across trials and would not need error correction or need only slight error correction.

### SUMMARY

A new fingerprinting method that is more reliable across trials than comparable previous approaches is disclosed herein below.

The method for chip fingerprinting of these teachings uses Data Retention Voltage (DRV) in SRAM as the identifier. The DRV of an SRAM is the minimum voltage at which its cells can retain state. DRV fingerprints are found to be more informative than other approaches for fingerprinting SRAM that have been proposed in research and commercially. The physical characteristics responsible for DRV are imparted randomly during manufacturing and therefore serve as a natural barrier against counterfeiting. The method of these teachings has the potential for wide application, as SRAM cells are among the most common building blocks of nearly all digital systems including smart cards and programmable RFID tags.

According to one aspect, the present disclosure provides a method and a system for characterizing an electronic device. The method comprises determining a physical fingerprint of an electronic device comprising a static random access memory (SRAM) array, using selected memory cells of the SRAM array, wherein the physical fingerprint comprises data retention voltages respectfully corresponding to the selected memory cells and storing data associated with the physical fingerprint in a database.

In one embodiment, determining the data retention voltage comprises a) writing a binary state in a first memory cell of the selected memory cells, b) applying a test voltage to a supply node of the first memory cell, and c) determining, after a predetermined wait time, whether a data retention failure occurs in the first memory cell. In one embodiment, if the data retention failure does not occur, reducing the test voltage by a predetermined step voltage, and repeating steps a), b), and c) until the data retention failure occurs. In one embodiment, the test voltage ranges from about 300 mV to about 20 mV, and the predetermined step voltage ranges from about 10 mV to about 140 mV, and the predetermined wait time ranges from about 2 ms to about 5 s.

In one embodiment, step a) of the method comprises writing the binary state in a non-volatile memory cell, and step c) of the method comprises reading, after the predetermined wait time, a logic state in the first memory cell, comparing the logic state in the first memory cell with the binary state in the non-volatile memory cell, and determining that the data retention failure occurs, if the logic state in the first memory cell differs from the binary state in the non-volatile memory cell. If the data retention failure occurs, then the test voltage is output as the data retention voltage of the first memory cell.

According to another aspect, the present disclosure provides a method and a system for identifying an electronic device. The method comprises characterizing a test device comprising a static random access memory (SRAM) array, wherein selected memory cells of the SRAM array respectfully comprises data retention voltages corresponding to a physical fingerprint of the test device, and comparing the physical fingerprint with a predetermined fingerprint stored in a database to determine whether the physical fingerprint and the predetermined fingerprint are within-class or between-class, wherein the predetermined fingerprint is associated with a target device to be identified.

In one embodiment, comparing the physical fingerprint with the predetermined fingerprint comprises calculating a distance between the first data retention voltage pairs associated with the physical fingerprint and the second data retention voltage pairs associated with the predetermined fingerprint. In one embodiment, calculating the distance comprises respectively subtracting the first data retention voltage pairs from the second data retention voltage pairs to obtain voltage difference pairs, respectively squaring elements of the voltage difference pairs to obtain voltage difference squares, and summing the voltage difference squares to obtain a value representing the distance. In one embodiment, if the distance is less than a predetermined value, the physical fingerprint and the predetermined fingerprint are within-class, and the test device is identified as the target device, and if the distance is greater than or equal to a predetermined value, the physical fingerprint and the predetermined fingerprint are between-class, and the test device is not identified as the target device. The physical fingerprint and the predetermined fingerprint are within-class, if the physical fingerprint and the predetermined fingerprint are generated from identical sets of memory cells in an identical device.

Given the low cost of the several bytes of SRAM that are used for DRV fingerprinting, a relatively significant practical cost may be associated with the generation of the test voltages for characterizing the DRVs. Emerging devices such as computational RFIDs can use software routines to extract DRVs, but as contactless devices they must generate all test voltages on-chip. On-chip dynamic control of SRAM supply voltage is assumed in the low-power literature at least since work on drowsy caches. Supply voltage tuning has also been applied with canary cells to detect potential SRAM failures, and as a post-silicon technique to compensate for process variation and increase manufacturing yields.

For a better understanding of the present teachings, together with other and further needs thereof, reference is made to the accompanying drawings and detailed description.

### BRIEF DESCRIPTION OF THE DRAWINGS

FIG. 1 shows the joint probability distribution function over all cells of the two variables (v⁰_{c} and v¹_{c}) comprising a DRV characterization, in accordance with one embodiment of the present disclosure;

FIG. 2 shows that a loss of measurement precision reduces entropy of each cell's DRV characterization, as Δ is swept from 10 mV to 140 mV, in accordance with one embodiment of the present disclosure;

FIG. 3 shows that for each of the 4 most frequently observed weak DRVs (as shown in Table 1a, infra), the DRV in a second trial from a cell that produced the frequently observed;

FIG. 4 shows that for each of the 4 most frequently observed strong DRVs (see Table. 1b, infra), the DRV in a second trial from a cell that produced the frequently observed DRV in a first trial;

FIG. 5a shows that 98.6% of SRAM cells with strongly 0 DRV reliably power-up to state 0, as observed by a mean power-up state of 0;

FIG. 5b shows that 95.1% of SRAM cells with strongly 1 DRV reliably power-up to state 1, as observed by a mean power-up state of 1;

FIGS. 6a and 6b show within-class and between-class distances of 16-bit fingerprints;

FIGS. 7a and 7b show that Tradeoff points of precision and recall for trials of DRV fingerprints are generally closer to the ideal result of perfect precision and recall;

FIG. 8 shows within-class distances when one fingerprint observation is made at various environmental temperatures; and

FIG. 9 shows a computer architecture/hardware, which may be used to implement the systems and methods of the present disclosure.

### DETAILED DESCRIPTION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

The following detailed description presents the currently contemplated modes of carrying out the invention. The description is not to be taken in a limiting sense, but is made merely for the purpose of illustrating the general principles of the invention, since the scope of the invention is best defined by the claims.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.”

### 1. Data Retention Voltage

A data retention failure may occur when an SRAM cell spuriously flips state due to insufficient supply voltage. The data retention voltage (DRV) of an SRAM array signifies the minimum supply voltage at which all SRAM cells can store an arbitrary state. DRV is studied in the literature as a limit to supply voltage scaling. Various simulation models and silicon measurements show modern SRAM DRVs to be under 300 mV.

Most existing literature focuses on cases where the supply voltage of the circuit remains safely above DRV. While remaining above DRV, the supply voltage can be adjusted to reduce leakage power, compensate for manufacturing variability, or compensate for environmental variations.

Each SRAM cell uses the positive feedback of cross-coupled inverters to hold a state on two complementary storage nodes. Retention failures may occur at low supply voltages because the low voltage weakens the positive feedback of the cross-coupled inverters. Due to asymmetric process variation, at some low supply voltages, a transition from a written state to the opposite state becomes inevitable; observations about the direction of such transitions and the voltages at which they occur are the basis for DRV fingerprints. Any collection of SRAM cells has a distinctive DRV fingerprint because of its unique random process variation.

### 2. Characterizing DRV of SRAM Cell

The DRVs of SRAM cells may be characterized by repeatedly lowering the SRAM supply voltage and observing the highest voltage at which each cell fails. If the SRAM supply node also supplies the processing core, then the low voltages used for the characterization may cause the core to reset and lose its state.

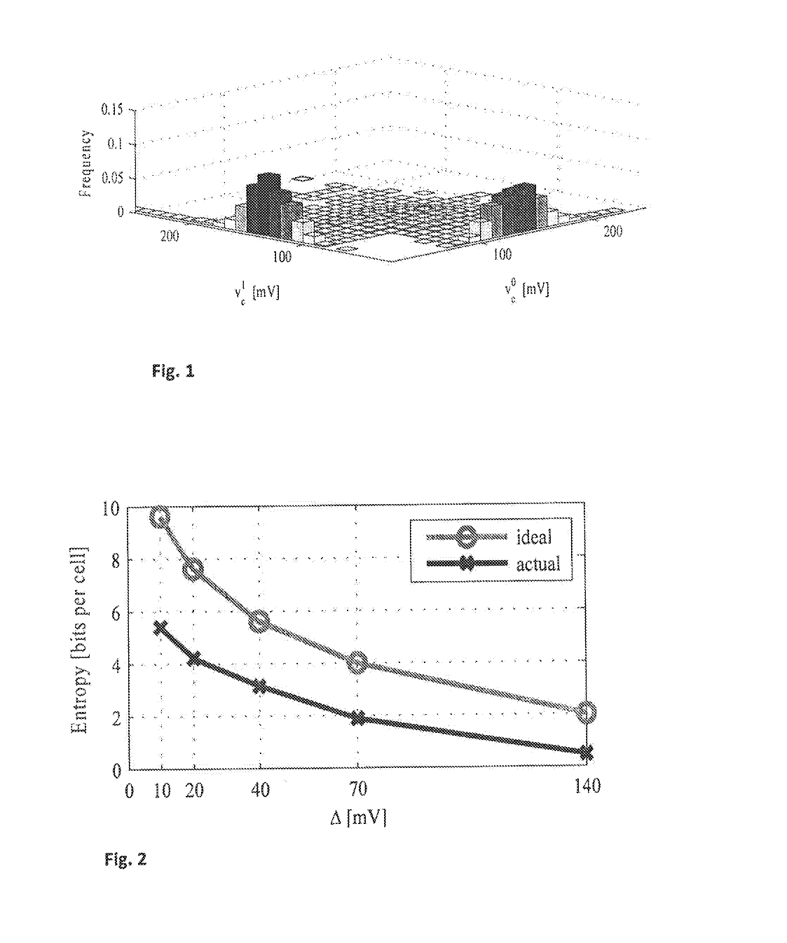

The experiments described in this disclosure avoid this difficulty by using non-volatile memory to maintain persistency across the low voltages. However, a custom integrated circuit designed for DRV fingerprinting can also avoid this difficulty by using an SRAM supply node that is decoupled from the nominal supply node of the processor. This is often done, for example, in power-gated circuits where unused on-chip functional blocks are turned off entirely while the chip as a whole remains powered. The DRV of an SRAM cell c may be characterized with a pair [symbol] v_{c}⁰, v_{c}¹ [symbol] . Each v_{c}^{w} (w=0 or 1) in the pair represents the highest voltage at which cell c will have a retention failure after state w is written to it. In principle, v_{c}⁰ and v_{c}¹ are real-valued (i.e., a continuous value); but in practice, each of v_{c}⁰ and v_{c}¹ may be approximated using one of N, for example, N=(300 mV−20 mV)/Δ discrete values as shown, in one embodiment, in Algorithm 1. With Δ set at 10 mV, in one instance, not a limitation of these teachings, in the instance in which N=28, the N=28 possible discrete values for v_{c}⁰ and v_{c}¹ are {20 mV; 30 mV; : : : ; 290 mV}. The frequency of observing different DRV pairs is shown in the joint probability distribution function of variables v_{c}⁰ and v_{c}⁰ in FIG. 1.

Algorithm 1 Characterize the DRV fingerprint of a set of SRAM cells.

```
Prerequisite: C - a set of SRAM cells
Ensure: v_{c}⁰, v_{c}¹ - the DRV characterizations of each SRAM cell c ε C.
  1: Let Vₙₒₘ be the nominal supply voltage (V_{dd}) for the chip
  2: Let s_{c} refer to the logical state of SRAM cell c ε C.
  3: Let s_{c}^{l} refer to the logical state of NVM cell that corresponds to SRAM cell c.
  4: for w = 0.1 do
  5:  for c ε C do
  6:  s_{c} ← w  {write w into SRAM cell}
  7:  s_{c}^{l} ← w  {write w into NVM cell}
  8:  v_{c}^{w} ← 0  {value used if no retention failure observed}
  9:  end for
10:  vₜₑₛₜ ← 300mV  {initialize test voltage}
11:  while vₜₑₛₜ > 20mV do
12:  lower chip voltage from Vₙₒₘ to vₜₑₛₜ
13:  wait for t_{wait} seconds
14:  raise chip voltage from vₜₑₛₜ to Vₙₒₘ
15:  for c ε C do
16:  if (sₑ = −w) Λ (+s_{c}^{l} = w) then
17:  SRAM cell c had a retention failure from state w at voltage vₜₑₛₜ, but
          previously had no failure at voltage vₜₑₛₜ+Δ. Therefore v ₜₑₛₜ approximates
          the largest voltage that induces a retention failure after writing w.
18:  v_{c}^{w} ← vₜₑₛₜ
19:  end if
20:  s_{c}^{l} ←+o s_{c} {write SRAM to NVM}
21:  end for
22:  vₜₑₛₜ ←+o vₜₑₛₜ − Δ {try a lower voltage next}
23:  end while
24: end for
```

2.1. Experimental Setup

The DRV of SRAM cells may be examined using Algorithm 1 implemented in the exemplary embodiments given below. Exemplary embodiments are presented below to elucidate the present disclosure, but it should be noted that the present teachings are not limited only to those exemplary embodiments. A microcontroller runs a program that sets all available memory bits to either 1 or 0. The supply voltage is then decreased to a value between 300 mV and 20 mV (Δ=10 mV) for 5 seconds. When supply voltage is restored to 3V, the program stores the content of SRAM to the flash memory. Note that a conservatively long wait time of t_{wait}=5 s is used to avoid missing marginal failures. Simulations using a procedure similar to Algorithm 1 for tuning the supply voltage show that waiting for t_{wait}=2 ms at a reduced supply voltage is sufficient to observe retention failures. An Agilent U2541A-series data acquisition (DAQ) unit controls the supply voltage and the timing of when voltage is raised and lowered. Thermal tests are conducted inside of a Sun Electronics EC12 Environmental Chamber and an OSXL450 infrared non-contact thermometer with +/−2° C. accuracy is used to verify the temperature. All experiments use instances of Texas Instruments MSP430 F2131 microcontrollers with 256 bytes of SRAM, of which 240 bytes are available for DRV fingerprinting. The DRV of each cell is characterized 20 times. The total runtime to characterize all 240 bytes of SRAM on a chip once using Algorithm 1 is given by t_{proc} in Eq. 1, and is 140 seconds for the conservative case of Δ=10 mV and t_{wait}=5 s.

$${t}_{proc} = {t}_{wait} \times \frac{300 mV - 20 mV}{Δ} \qquad ( 1 )$$

2.2. Information Content of SRAM Cell DRV

The DRV of each cell has N² possible outcomes representing all combinations of N outcomes for v_{c}⁰ and the N outcomes for v_{c}¹ (in this particular embodiment, N=28). The DRV of each cell is then a random variable X with N² outcomes denoted xᵢ (i.e., x_{—}{0}through x_(N²−1)). The total entropy H(X) is the expected information value of the DRV of an unknown cell. Entropy depends (per Eq. 2) on the probabilities of each DRV outcome, denoted p(xᵢ). In the ideal case where all N² outcomes are equally likely (e.g., p(xᵢ)=1/N², for all xᵢ), each DRV would have almost 10 bits of entropy. Applying Eq. 2 to the decidedly non-uniform outcome probabilities of FIG. 1 shows the actual entropy of a DRV to be 5.12 bits. The most frequently observed DRV outcomes are given in Table. 1.

TABLE 1
The 4 most commonly observed weak and strong DRV characterizations,
and the probability of observing each in a randomly selected trail.

| Outcome | | Outcome | |
|---|---|---|---|
| (v_{c}⁰, v_{c}¹) | Freq. | (v_{c}⁰, v_{c}¹) | Freq. |
| (130 mV, 100 mV) | 0.0096 | (20 mV, 130 mV) | 0.0893 |
| (120 mV, 100 mV) | 0.0076 | (20 mV, 120 mV) | 0.0719 |
| (130 mV, 110 mV) | 0.0070 | (130 mV, 20 mV) | 0.0685 |
| (120 mV, 110 mV) | 0.0070 | (20 mV, 140 mV) | 0.0651 |

| | |
|---|---|
| (a) Most common weak DRVs | (b) Most common strong DRVs |

Eq. 1 shows that runtime is inversely proportional to Δ. Accordingly, it is considered information loss, when Δ is made larger than 10 mV. FIG. 2 shows the ideal and actual entropy of DRV characterizations when different values of Δ are used. In the extreme case where Δ=140 mV, variables v_{c}⁰ and v_{c}¹ are each restricted to the values {20 mV; 160 mV}, so the ideal entropy of the DRV is equivalent to 2 flips of a fair coin. The values of Δ used in FIG. 2 are chosen on account of being unambiguously recreatable from the Δ=10 mV data.

H(X)=−Σᵢp(xᵢ)log p(xᵢ) (2)

2.3. Observations about Strong and Weak Cells

The N² possible DRV characterizations (FIG. 1) may be categorized into three classes. Note that no observation of [symbol] v_{c}⁰, v_{c}¹ [symbol] = [symbol] 20 mV, 20 mV [symbol] is ever made, so this outcome is not included in any of the three classes that are sufficient to demonstrate general observations of all DRVs.
A strongly 0 DRV characterization is a pair [symbol] v_{c}⁰, v_{c}¹ [symbol] such that v_{c}⁰=20 mV and v_{c}¹>20 mV. A strongly 0 DRV indicates that no retention failure occurs at any voltage vₜₑₛₜ after state 0 is written.
A strongly 1 DRV characterization is a pair [symbol] v_{c}⁰, v_{c}¹ [symbol] such that v_{c}⁰>20 mV and v_{c}¹=20 mV. A strongly 1 DRV indicates that no retention failure occurs at any voltage vₜₑₓₜ after state 1 is written.
A weak DRV characterization is a pair [symbol] v_{c}⁰, v_{c}¹ [symbol] such that v_{c}⁰>20 mV and v_{c}¹>20 mV. A weak DRV indicates that a failure is observed at some voltage vₜₑₛₜ after each state is written.

The variation-dependent behavior of an SRAM cell occurs somewhere between 20 mV and 300 mV for each cell; above 300 mV all cells can reliably hold either the 0 or the 1 state, and below 20 mV no cells can do so. When a cell produces a strongly 0 or strongly 1 characterization, it means (per Algorithm 1) that, for any one written state, the supply voltage can be lowered all the way through the sensitive region down to 20 mV and then raised back up without causing a data retention failure. Therefore, a strongly 0 or strongly 1 characterization indicates a strong preference for one state over the other at all supply voltages. A weak characterization is when each written state flips at some voltage within the sensitive region, and neither state can be retained when the supply voltage is lowered down to 20 mV.

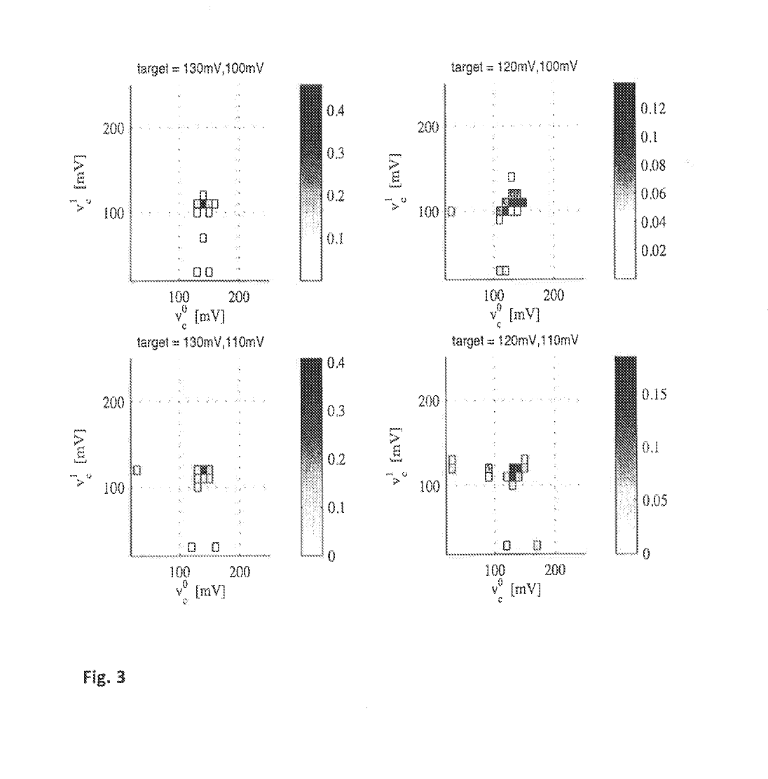

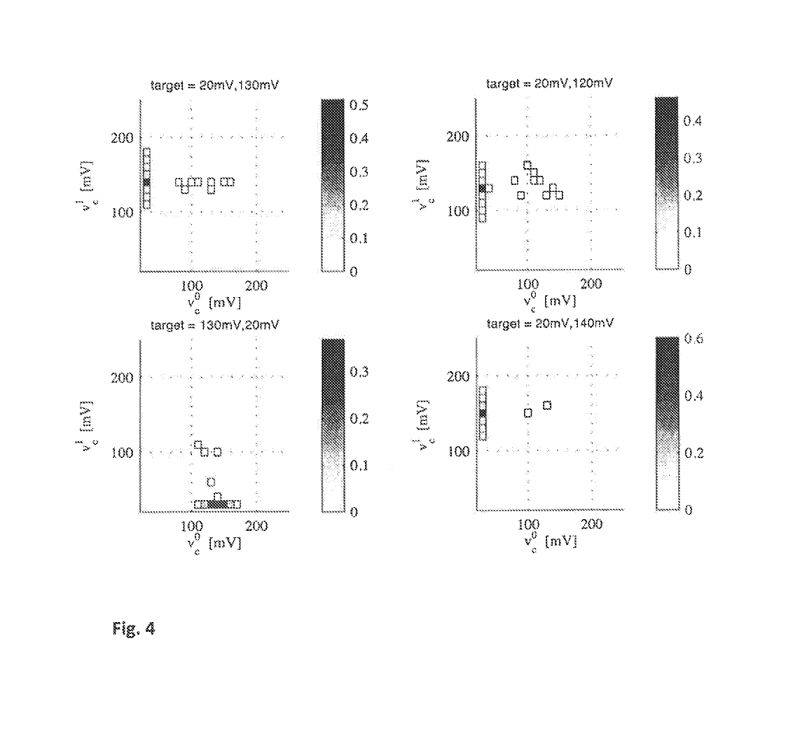

Both strong and weak DRV characterizations are largely repeatable across trials. FIG. 3 shows the distribution of DRVs produced by randomly selected cells for which the first DRV produced is one of the 4 most commonly observed weak DRVs from Table 1a; each plot shows the conditional probability distribution of a subsequent DRV characterization. Occasionally, the same cells that produce a weak DRV produce a strong DRV in subsequent trials. FIG. 4 shows the same analysis for the 4 most commonly observed strong DRVs; none of the cells subsequently produces the opposite strong characterization.

2.4. Relation to Power-Up State

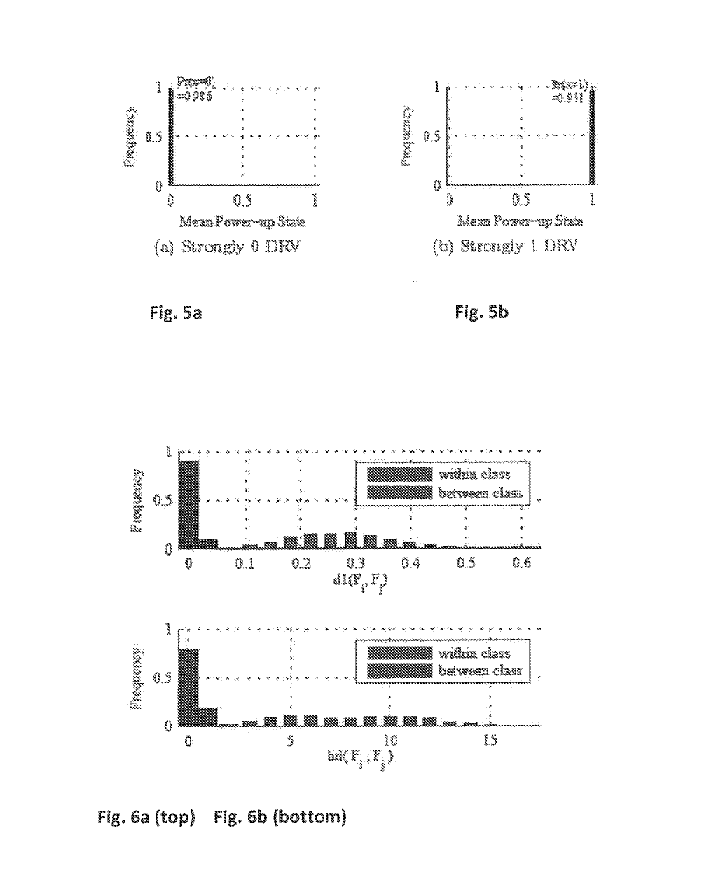

It is known that SRAM cells consistently power-up to the same state in a majority of trials. Cells with highly reliable power-up states tend to be the same cells with strong DRV characterizations. FIG. 5 shows the mean power-up state over 28 trials for cells that produced a strongly 0 or strongly 1 DRV characterization. Among cells with strongly 0 DRV, 98.6% power-up to the 0 state in all 28 power-up trials (FIG. 5a). Similarly, 95.1% of cells characterized as strongly 1 consistently power-up to the 1 state (FIG. 5a). Although a strong DRV fingerprint is correlated to power-up tendency, the DRV provides a more informative identifier than does power-up by providing information about the maximum voltage at which the unfavored state cannot be reliably stored.

### 3. Fingerprint Matching

A DRV fingerprint is obtained from a single characterization of a set of adjacent cells within an SRAM. A k-bit fingerprint Fᵢ comprises cell characterizations [symbol] vᵢ⁰, vᵢ¹ [symbol] , [symbol] vᵢ₊₁⁰, vᵢ₊₁¹ [symbol] . . . [symbol] vᵢ₊₍ₖ₋₁₎⁰, vᵢ₊₍ₖ₋₁₎¹ [symbol] .

The difference between fingerprints is the sum of the differences between their corresponding single-cell characterizations. Recalling that each DRV is a point [symbol] v_{c}⁰, v_{c}¹ [symbol] in 2-dimensional space, the distance between two DRVs is defined according to the square of their distance along each dimension (Eq. 3). For comparison, a second metric used is the Hamming distance between power-up trials; this is shown by Eq. 4, where pᵢ is the state of the i-th bit of SRAM after a power-up.

$$\begin{matrix}d 1 ( {F}_{i} , {F}_{j} ) = {\sum }_{n = 0}^{k - 1} {( {v}_{i + n}^{0} - {v}_{j + n}^{0} )}^{2} + {( {v}_{i + n}^{1} - {v}_{j + n}^{1} )}^{2} & ( 3 ) \\ hd ( {F}_{i} , {F}_{j} ) = {\sum }_{n = 0}^{k - 1} {p}_{i + n} ⊕ {p}_{j + n} & ( 4 )\end{matrix}$$

TABLE 2
Probability of different pairwise outcomes when 2 DRV fingerprints
are taken from a randomly chosen cell. Over the 5000 samples
collected, no cell ever has a DRV that is strongly 1 in one trial
and strongly 0 in another, but 5.6% of outcomes have one
strong and one weak DRV.

| | Strongly 0 | Weak | Strongly 1 |
|---|---|---|---|
| Strongly 0 | 35.80% | 3.10% | 0.00% |
| Weak | — | 24.98% | 2.48% |
| Strongly 1 | — | — | 33.64% |

Since the metric for a difference between fingerprints can be a multidimensional distance or a Hamming distance, the distance between fingerprints, as used herein, is measured in “distance units,” where a distance unit can be volts² (or millivolts²), when the distance is expressed in terms of the sum of squares of differences in voltage, or can be dimensionless, as in the case of a Hamming distance.

3.1. Identification at Nominal Temperature

At the nominal operating temperature of 29° C., three experiments compare DRV fingerprints with power-up fingerprints. These experiments are explained in the following subsections; the first shows the histograms of distances between fingerprints, and the second and third evaluate the accuracy of distance-based matching.

3.1.1. Histogram of Distances Between Fingerprints

A first experiment shows that DRV fingerprints are repeatable and unique, as is necessary for successfully identifying chips within a population. Within-class pairings are of multiple fingerprints generated by the same set of cells on the same device. Between-class pairings are from different sets of cells on the same device, or from any sets of cells on different devices. The similarity of any two fingerprints is quantified by a distance, and this distance is the basis for determining the correct identity of a fingerprint. If within-class fingerprint pairings consistently have smaller distances than between-class pairings, then it is possible to determine identity by choosing an appropriate threshold that separates the two classes. The histograms of within-class and between-class distances for DRV and power-up fingerprints are shown in FIG. 6. These histograms represent all data collected from the MSP430F2131 microcontrollers at room temperature. The distances on the x-axes are not directly comparable across metrics; of importance is only whether the two classes are clearly separable within each plot.

3.1.2. Accuracy of Top Match

The next experiment performed at nominal temperature evaluates how reliably a single within-class DRV fingerprint can be identified among a population. This experiment matches a single 16-bit target fingerprint against a population containing another fingerprint from the same cells and one fingerprint from each of the 239 remaining locations across 2 chips. A positive result occurs if the closest match among the 240 possibilities is from the same SRAM cells as the target. The results of the top match experiment are shown in Table 3; the column labeled “co-top” shows the percentage of trials where there are multiple top matches and one of them correctly matches the target. Multiple top matches are relatively common in Hamming distance matching due to the small number of possible distances between fingerprints. Compared to power-up fingerprints, matching based on DRV fingerprints is 28% more likely to have the correct match be closer to the target (i.e., separated by a smaller distance) than all incorrect matches.

TABLE 3
Over 300 trials with a population of 240 16-bit fingerprints, DRV
identification returns the fingerprint that correctly matches the
target more reliably than power-up state identification. Matching
based on power-up state more frequently returns a misidentified
fingerprint, or returns multiple fingerprints among which one is the
correct match (denoted “co-top”).

| | top | co-top | misidentified |
|---|---|---|---|
| DRV (d1) | 99.7% | — | 0.3% |
| Power-up | 71.7% | 24.7% | 3.6% |

3.1.3. Precision and Recall

The top match experiment is generalized to the case of identifying multiple correct matches among a larger population, and again shows DRV fingerprints to outperform power-up fingerprints. In this experiment, the goal is to find all correct matches in the population, without also finding too many incorrect matches. In doing so, the distance that is considered to be the threshold between a correct and incorrect match can be adjusted. If the threshold is too low, then correct matches may not be identified, but if the threshold is too high then false positives will occur. Recall refers to the fraction of within-class pairings under the threshold, and precision refers to the fraction of pairings under the threshold that are within-class. Increasing the threshold may sacrifice precision for recall, and decreasing the threshold may sacrifice recall for precision. An ideal result is for both precision and recall to be 1; this result occurs if all correct matches are identified as within-class (perfect recall) with no incorrect ones identified as within-class (perfect precision).

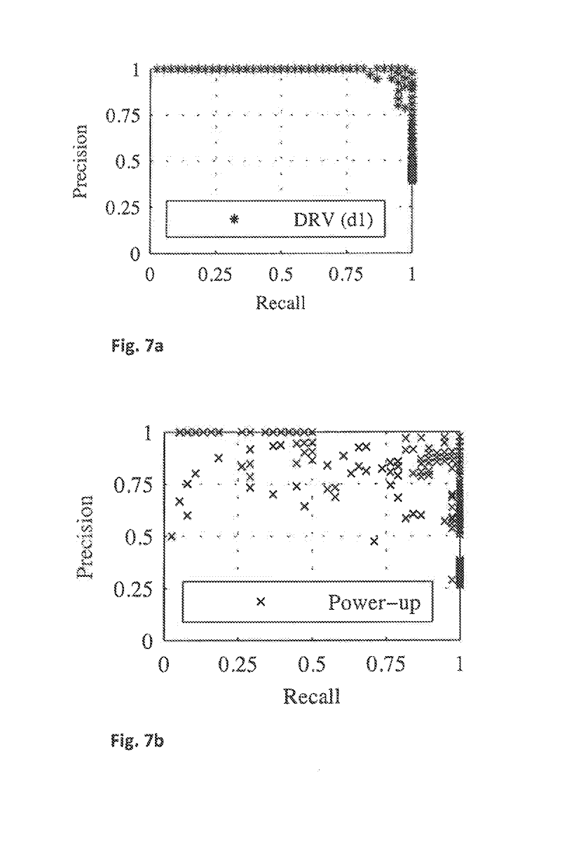

The precision and recall plots of FIG. 7 are obtained by iterating the following procedure. One 16-bit segment of SRAM is chosen for identification. One fingerprint trial from this segment is chosen at random as the target, and it is matched against a population of 1019 fingerprints comprising 19 from the same SRAM segment (within-class pairings) and 1000 non-matching fingerprints (between-class pairings). The non-matching fingerprints are randomly selected among 20 trials from 239 other segments of SRAM. The 239 eligible 16-bit segments are the 119 remaining on the target's own chip, and all 120 such locations on the other device. The matching threshold is swept to find achievable precision-versus-recall tradeoffs, and each achievable tradeoff is a point in FIG. 7. The large number of tradeoff points in the plot is collected from multiple iterations of this procedure. The general trend is that DRV fingerprints produce better recall for a given precision, or better precision for a given recall compared to power-up fingerprints.

3.2. Impact of Temperature Variations

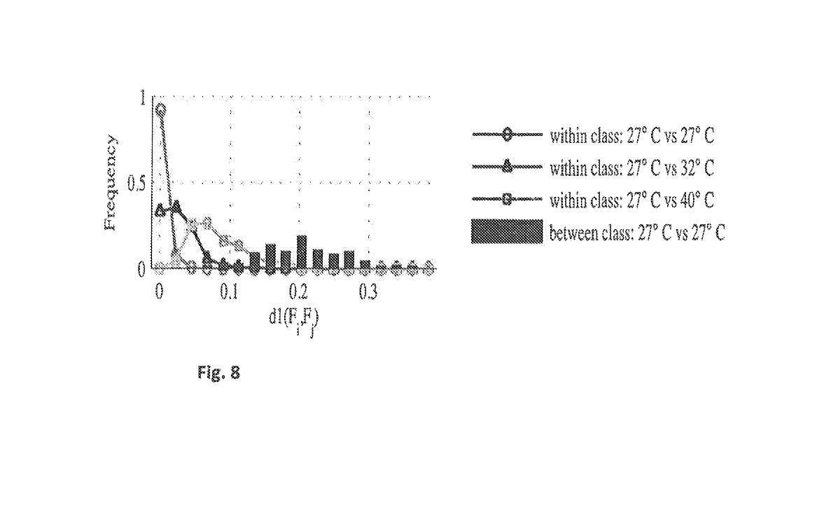

Given that DRV fingerprints would likely be used in real-world scenarios without precisely-controlled temperatures, this experiment explores the impact of temperature on DRV fingerprints. This experiment is similar to the experiment of subsection 3.1.1, but the pairs of fingerprint observations used to generate the within-class distances are now made at different temperatures. The results are shown in FIG. 8. The increase of within-class distances across temperature implies a diminished reliability. To compensate for this, larger fingerprints (comprising more bits) may be needed for identification, and more robust error correcting codes may be needed in key-generation applications. If the increased within-class distances are due to a uniform shift in the DRVs of all cells, then a promising direction for future work would be to design a matching scheme that is insensitive to this type of uniform shift.

As demonstrated hereinabove, SRAM DRV fingerprints are static identifiers of a device, and it a simple characterization procedure and matching algorithms has been disclosed to use them as such. DRV fingerprints are similar to previously demonstrated power-up fingerprints, but they provide a more informative non-binary identifier of each cell. As a result of this, DRV fingerprints are identified up to 28% more reliably than are power-up fingerprints.

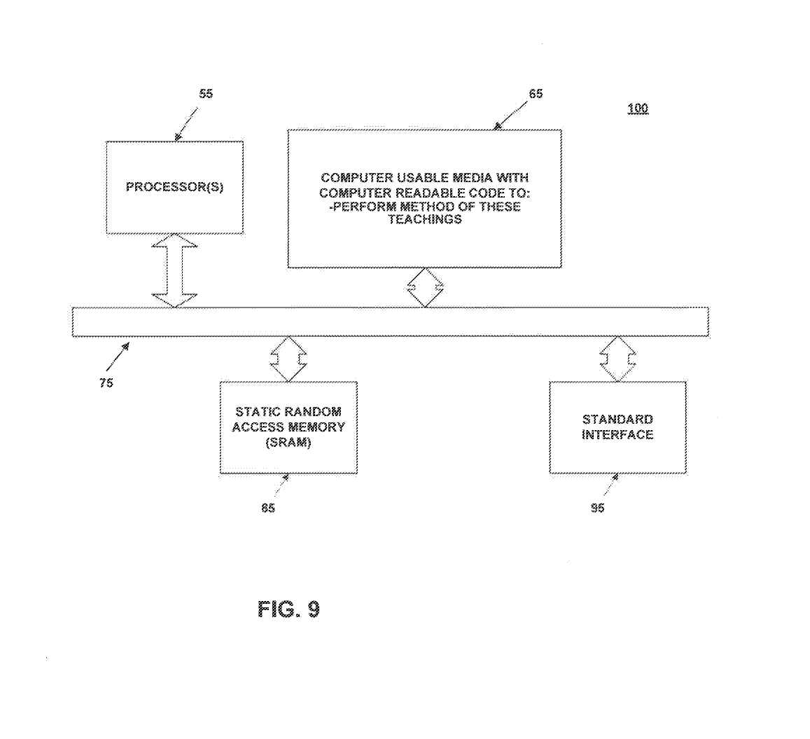

Embodiments of the present disclosure can be included in methods and systems for identification or authentication. FIG. 9 shows a computer architecture/hardware 100, which may be used to implement the systems and methods for identification or authentication of the present disclosure. The computer hardware 100 includes one or more processors 55, a computer usable media 65 (such as, hard drive, CD/DVD ROM, flash memory, etc.) with computer readable code to perform the methods of the present disclosure, a static random access memory (SRAM) 85 to be used as for providing fingerprints, and a standard interface 95 for connecting the computer hardware 100 with additional peripheral devices or other remote computer systems through a communication network. The computer hardware 100 further include a BUS 75 for interconnecting one or more processors 55, computer usable media 65, SRAM 85, and standard interface 95.

The SRAM DRV fingerprints can be obtained upon fabrication of the SRAM and stored in a memory, such as a database. A circuit or object can be identified or authenticated by characterizing the SRAM DRV, using algorithm I disclosed above, and comparing the resulting SRAM DRV to the database. A system of these teachings for identification/authentication, in one embodiment, includes a measurement system, as disclosed herein above, for characterizing the SRAM DRV and an analysis subsystem for comparing the resulting SRAM DRV to the database. In one instance, the measurement system includes at least one processor and computer usable media having computer readable code that causes the at least one processor to execute algorithm I. In one embodiment, the database storing the SRAM DRV fingerprints may be implemented in a remote server hardware accessible to the analysis subsystem through a communication network (e.g., local area network, wide area network, wired/wireless network, etc.). The analysis subsystem, in one instance, also includes at least one processor and computer usable media that has computer readable code that causes the at least one processor to retrieve the SRAM DRV fingerprint and compare the SRAM DRV obtained from the characterization to the fingerprint.

For the purposes of describing and defining the present teachings, it is noted that the term “substantially” may be utilized herein to represent the inherent degree of uncertainty that may be attributed to any quantitative comparison, value, measurement, or other representation. The term “substantially” may also be utilized herein to represent the degree by which a quantitative representation may vary from a stated reference without resulting in a change in the basic function of the subject matter at issue.

Further, for the purposes of describing and defining the present teachings, it is noted that the term “configured to” may be utilized herein to represent a computer usable media having computer readable code embodied therein, the computer readable code being executed in a processor to perform certain method steps.

Although embodiments of the present invention has been described in detail, it is to be understood that these embodiments are provided for exemplary and illustrative purposes only. Various modifications and changes may be made by persons skilled in the art without departing from the spirit and scope of the present disclosure as defined in the appended claims.

What is claimed is:

1. A method for characterizing an electronic device, comprising:
determining a physical fingerprint of an electronic device comprising a static random access memory (SRAM) array, using selected memory cells of the SRAM array, wherein the physical fingerprint comprises data retention voltages respectively corresponding to the selected memory cells; and
storing data associated with the physical fingerprint in a database.

2. The method of claim 1, wherein determining the physical fingerprint comprises determining a data retention voltage for each of the selected memory cells.

3. The method of claim 2, wherein determining the data retention voltage comprises:
(3-1) writing a binary state in a first memory cell of the selected memory cells;
(3-2) applying a test voltage to a supply node of the first memory cell; and
(3-3) determining, after a predetermined wait time, whether a data retention failure occurs in the first memory cell.

4. The method of claim 3, further comprising, if the data retention failure does not occur, reducing the test voltage by a predetermined step voltage, and repeating steps (3-1), (3-2), and (3-3) until the data retention failure occurs.

5. The method of claim 4, wherein the test voltage ranges from about 300 mV to about 20 mV, and the predetermined step voltage ranges from about 10 mV to about 140 mV.

6. The method of claim 3, further comprising, if the data retention failure occurs, outputting the test voltage as the data retention voltage of the first memory cell.

7. The method of claim 3, wherein step (3-1) comprises writing the binary state in a non-volatile memory cell.

8. The method of claim 7, wherein step (3-3) comprises:
reading, after the predetermined wait time, a logic state in the first memory cell;
comparing the logic state in the first memory cell with the binary state in the non-volatile memory cell; and
determining that the data retention failure occurs, if the logic state in the first memory cell differs from the binary state in the non-volatile memory cell.

9. The method of claim 3, wherein the predetermined wait time ranges from about 2 ms to about 5 s.

10. The method of claim 3, wherein the binary state comprises a ZERO state and a ONE state.

11. The method of claim 10, wherein the physical fingerprint comprises voltage pairs respectively corresponding to the selected memory cells.

12. The method of claim 11, wherein selected one of the voltage pairs comprises a data retention voltage of a corresponding one of the selected memory cells at the ZERO state and a data retention voltage of the corresponding one of the selected memory cells at the ONE state.

13. The method of claim 1, wherein each of the selected memory cells comprises cross-coupled inverters.

14. The method of claim 1, wherein each of the selected memory cells comprises a supply node for receiving power, the supply node being coupled to a power-gating device.

15. A method for identifying an electronic device, comprising:
characterizing a test device comprising a static random access memory (SRAM) array, wherein selected memory cells of the SRAM array respectfully comprises data retention voltages corresponding to a physical fingerprint of the test device; and
comparing the physical fingerprint with a predetermined fingerprint stored in a database to determine whether the physical fingerprint and the predetermined fingerprint are within-class or between-class, wherein the predetermined fingerprint is associated with a target device to be identified.

16. The method of claim 15, wherein the predetermined fingerprint comprises first data retention voltage pairs respectively corresponding to selected memory cells in the target device to be identified, and wherein the physical fingerprint comprises second data retention voltage pairs respectively corresponding to the selected memory cells in the test device.

17. The method of claim 16, wherein selected one of the first data retention voltage pairs comprises a data retention voltage of a ZERO state in a corresponding one of the selected memory cells, and a data retention voltage of a ONE state in the corresponding one of the selected memory cells.

18. The method of claim 16, wherein selected one of the second data retention voltage pairs comprises a data retention voltage of a ZERO state in a corresponding one of the selected memory cells, and a data retention voltage of a ONE state in the corresponding one of the selected memory cells.

19. The method of claim 16, wherein comparing the physical fingerprint with the predetermined fingerprint comprises:
calculating a distance between the first data retention voltage pairs associated with the physical fingerprint and the second data retention voltage pairs associated with the predetermined fingerprint.

20. The method of claim 19, wherein if the distance is less than a predetermined value, the physical fingerprint and the predetermined fingerprint are within-class, and the test device is identified as the target device.

21. The method of claim 19, wherein, if the distance is greater than or equal to a predetermined value, the physical fingerprint and the predetermined fingerprint are between-class, and the test device is not identified as the target device.

22. The method of claim 19, wherein calculating the distance comprises:
respectively subtracting the first data retention voltage pairs from the second data retention voltage pairs to obtain voltage difference pairs;
respectively squaring elements of the voltage difference pairs to obtain voltage difference squares; and
summing the voltage difference squares to obtain a value representing the distance.

23. The method of claim 20, wherein the predetermined value is about 0.1 distance unit.

24. The method of claim 15, wherein the physical fingerprint and the predetermined fingerprint are within-class, if the physical fingerprint and the predetermined fingerprint are generated from identical sets of memory cells in an identical device.

25. A system for characterizing an electronic device, comprising:
a processor;
memory coupled to the processor for storing a database; and
a measurement subsystem configured to:
determine a physical fingerprint of an electronic device comprising a static random access memory (SRAM) array, using selected memory cells of the SRAM array, wherein the physical fingerprint comprises data retention voltages respectfully corresponding to the selected memory cells; and
storing data associated with the physical fingerprint in the database.

26. The system of claim 25, wherein the measurement subsystem is further configured to determine a data retention voltage for each of the selected memory cells.

27. The system of claim 26, wherein the measurement subsystem is further configured to:
(3-1) write a binary state in a first memory cell of the selected memory cells;
(3-2) apply a test voltage to a supply node of the first memory cell; and
(3-3) determine, after a predetermined wait time, whether a data retention failure occurs in the first memory cell.

28. The system of claim 27, wherein the measurement subsystem is further configured to, if the data retention failure does not occur, reduce the test voltage by a predetermined step voltage, and repeat (3-1), (3-2), and (3-3) until the data retention failure occurs.

29. The system of claim 28, wherein the test voltage ranges from about 300 mV to about 20 mV, and the predetermined step voltage ranges from about 10 mV to about 140 mV.

30. The system of claim 27, wherein the measurement subsystem further configured to, if the data retention failure occurs, outputting the test voltage as the data retention voltage of the first memory cell.

31. The system of claim 30, wherein (3-3) of the measurement subsystem is further configured to:
read, after the predetermined wait time, a logic state in the first memory cell;
compare the logic state in the first memory cell with the binary state in the non-volatile memory cell; and
determine that the data retention failure occurs, if the logic state in the first memory cell differs from the binary state in the non-volatile memory cell.

32. The system of claim 27, wherein the predetermined wait time ranges from about 2 ms to about 5 s.

33. A system for identifying an electronic device, comprising:
a processor;
memory coupled to the processor for storing a database;
a measurement subsystem configured to characterizing a test device comprising a static random access memory (SRAM) array, wherein selected memory cells of the SRAM array respectfully comprises data retention voltages corresponding to a physical fingerprint of the test device; and
an analysis subsystem configured to compare the physical fingerprint with a predetermined fingerprint stored in the database to determine whether the physical fingerprint and the predetermined fingerprint are within-class or between-class, wherein the predetermined fingerprint is associated with a target device to be identified.

34. The system of claim 33, wherein the predetermined fingerprint comprises first data retention voltage pairs respectively corresponding to selected memory cells in the target device to be identified, and wherein the physical fingerprint comprises second data retention voltage pairs respectively corresponding to the selected memory cells in the test device.

35. The system of claim 34, wherein selected one of the first data retention voltage pairs comprises a data retention voltage of a ZERO state in a corresponding one of the selected memory cells, and a data retention voltage of a ONE state in the corresponding one of the selected memory cells.

36. The system of claim 34, wherein selected one of the second data retention voltage pairs comprises a data retention voltage of a ZERO state in a corresponding one of the selected memory cells, and a data retention voltage of a ONE state in the corresponding one of the selected memory cells.

37. The system of claim 34, wherein the analysis subsystem is further configured to calculate a distance between the first data retention voltage pairs associated with the physical fingerprint and the second data retention voltage pairs associated with the predetermined fingerprint.

38. The system of claim 37, wherein if the distance is less than a predetermined value, the physical fingerprint and the predetermined fingerprint are within-class, and the test device is identified as the target device; and wherein, if the distance is greater than or equal to the predetermined value, the physical fingerprint and the predetermined fingerprint are between-class, and the test device is not identified as the target device.

39. The system of claim 37, wherein the analysis subsystem is further configured to:
respectively subtract the first data retention voltage pairs from the second data retention voltage pairs to obtain voltage difference pairs;
respectively square elements of the voltage difference pairs to obtain voltage difference squares; and
sum the voltage difference squares to obtain a value representing the distance.

40. The system of claim 38, wherein the predetermined value is about 0.1 distance unit.

41. A system for characterizing an electronic device, comprising a processor and computer readable media having computer readable code embodied therein, the computer readable code being executed in the processor to perform the method of claim 1.

42. A system for identifying an electronic device, comprising a processor and computer readable media having computer readable code embodied therein, the computer readable code being executed in the processor to perform the method of claim 25.
